(19) United States
(12) Patent Application Publication
(10) Pub. No.: US 2007/0116044 A1
(43) Pub. Date: May 24, 2007

(54) Capture buffer, a network analyser, a network analyser card and a method of capturing network data

(75) Inventors: William Mark Dries, Southampton (GB); Alexander Carl Worrall, Denmead (GB); Timothy Peter Evan Williams, Hampshire (GB)

Correspondence Address: PILLSBURY WINTHROP SHAW PITTMAN, LLP, P.O. BOX 10500, MCLEAN, VA, 22102, US

(73) Assignee: XYRATEX TECHNOLOGY LIMITED, Hampshire (GB)

(21) Appl. No.: 11/522,526

(22) Filed: Sep. 18, 2006

Related U.S. Application Data
(60) Provisional application No. 60/729,743, filed on Oct. 25, 2005.

(51) Int. Cl. H04J 3/16; H04J 3/22

(52) U.S. Cl. 370/466

(57) ABSTRACT

A capture buffer stores data frames captured from a network which includes a data storage region for storing content data of the or each data frame received from the network, and for storing a descriptor associated with the or each data frame received from the network. The invention further includes an auxiliary storage region for storing an indicator of a property of a frame.

The present invention relates to a capture buffer, a network analyser card and a method of capturing network data.

Network test equipment such as a network analyser typically captures data frames from a network to which the equipment is connected, into a large capture buffer. Software may then be used to access the buffer and display data about the data frames using a graphical user interface, for a user to process or monitor. The capture buffer is typically implemented using SDRAM based memory. One example configuration of this type of memory typically used for this function is a Dual In-line Memory Module (DIMM).

Typically, when data is received into a network analyser, it is received as frames from the network to which the analyser is connected. The frames may be the typical frames of any communication protocol, e.g. TCP/IP etc. In some known network analysers, a descriptor is added to each of a number of received frames (preferably all of the frames). An example of such a network analyser is described in our co-pending International Patent Application number WO-A-2005/05786, the entire contents of which are hereby incorporated by reference.

The descriptor typically includes information relating to the frame to which it is attached. The descriptor, for example, may contain information about the wire length of the frame (i.e. the length of the frame as seen on the network), a time stamp to indicate the time of arrival of the frame at the network analyser and a current and previous block size. The current block size indicates the size of the current frame (including the descriptor and any padding which may need to be added for wider internal data path architectures) to which the descriptor is attached. The previous block size indicates the size of the immediately previous frame (including the descriptor and any padding which may need to be added for wider internal data path architectures) from the current frame to which the descriptor is attached. As typical network data rates increase, the number of data frames received in any given time increases correspondingly.

Conventionally, when seeking to locate a particular frame of data within the capture buffer, e.g. for use in an application on a host, the location of a particular descriptor is noted and the current block size is determined from the descriptor. Frames stored are normally of variable sizes and for example can be from a few bytes (10 or more) to tens of thousands of bytes.

It is possible to store only fixed size frames in order to speed up the searching process, however this requires network frames to be either truncated, or padded, or indeed both depending on the fixed size frame size used. When frames are truncated, information is lost, whereas when frames are padded, extra padding bytes that have no meaning are added and hence memory usage is increased and thus, performance may be negatively affected. The current block size is then added to the current descriptor location. This will point automatically to the location of the descriptor associated with the next consecutive frame. Similarly, by subtracting the previous block size from the current descriptor location, the descriptor of the previous frame can be located. This structure is typically referred to as a “linked list” and it enables any descriptor to be located eventually after one descriptor has first been located.

FIG. 1 shows a simplified schematic representation of a conventional capture buffer. The buffer has a number of data storage regions each for storing data from a particular frame, including the descriptor associated with the frame. For example, region 1₁ is for storing the descriptor associated with frame 1. Regions 1₁ to 1₅ are for storing the frame data or content associated with the first data frame received in the capture buffer. The locations of the descriptor and the frame data associated with the first frame correspond to the locations 0 to 4 within the capture buffer. As shown schematically in FIG. 1, the descriptor includes a “previous” and “current” field for indicating the size of the current frame and also the size of the previous frame, both of which include the descriptor size.

Memory data width size has no effect on how data is stored. DIMMs are usually 64 bits wide i.e. 8 bytes wide so it is necessary to store 8 bytes at a time to make efficient use of the memory and its controller. This is achieved by effectively dividing the received network frame by 8. Since the frame may not be in multiples of 8, any remainder is normally padded up to 8 i.e. the last frame data entry will contain between 1 and 7 “null” bytes. Doing it like this ensures that all stored data frames start on 8 byte boundaries.

The capture buffer shown in FIG. 1 is shown following a “capture until full” capture. To serve as an example, only the first 11 (0 to 10) locations are detailed. For this example, the buffer size is not important so the final location is simply detailed as N. N-1, etc simply refers to locations 1, etc before the end of the buffer. Although only N and N-1 are shown in FIG. 1, it will be understood that there are many N-X locations, where X will be between 2 and a number defining the size of the buffer.

In FIG. 1, the first 11 locations hold 3 complete frames. For this example, the contents on the rest of the buffer i.e. N, N-1, etc is irrelevant and is referred to as “X”-unknown. “Capture until full” always yields location 0 as the location within the buffer of the descriptor of the chronologically oldest data frame. The last location within the buffer of the descriptor of the chronologically newest complete data frame is also always known. Note that when the capture stops, it is possible that the last frame is not a complete frame. In this case, the last complete frame is referred to as the chronologically newest frame.

Navigating through the capture buffer to locate a particular descriptor can be achieved using either the oldest or newest descriptors. When using forward navigation, the chronologically oldest descriptor is read. The value of the current block size is then read from the descriptor and this value is added to the location of the current descriptor. This will take the reader to the location of the next descriptor. This process is repeated until the particular descriptor is located.

For navigating backwards, the chronologically newest descriptor is read. The value of the previous block size is then read from the descriptor and this value is subtracted from the location of the current descriptor. This will take the reader to the location of the previous descriptor. This process is repeated until the particular descriptor is located.

As the buffer may contain millions of frames both methods (forward navigation and backward navigation) can be a very slow process requiring a large number of processor cycles.

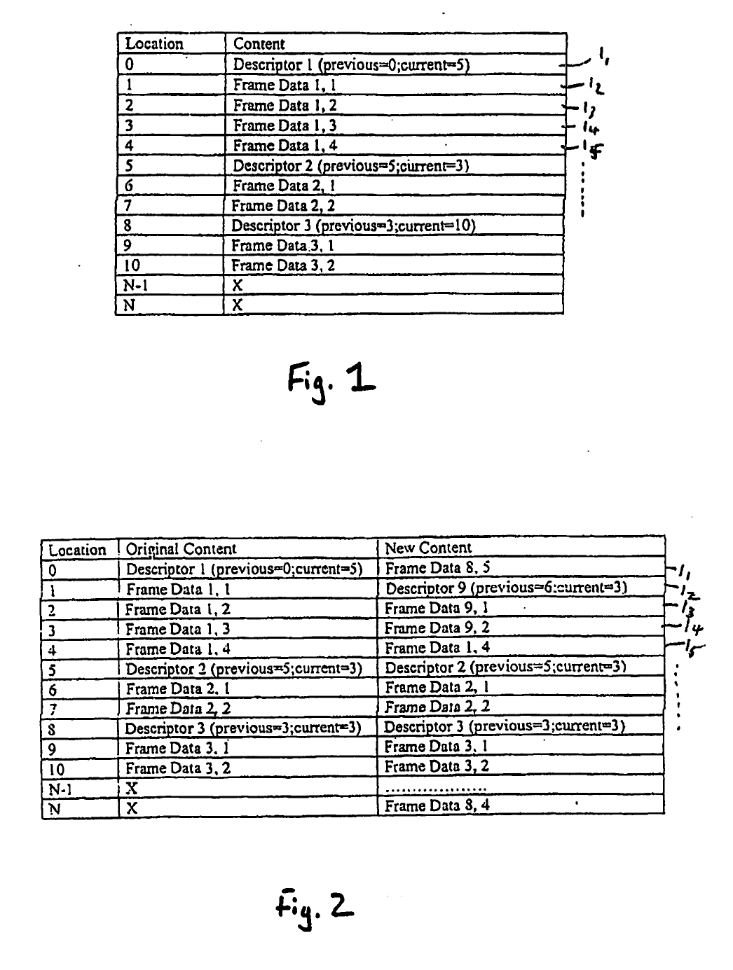

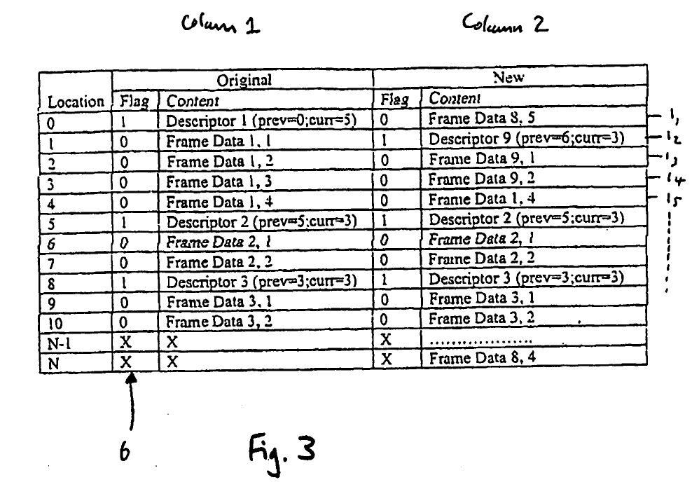

In some cases, it is necessary to capture data with “buffer wrap” enabled meaning that once the capture buffer is full, i.e. there is data in location N, new data subsequently received starts to overwrite data already stored in the capture buffer starting back at location 0. In such situations, new frame data can overwrite original frame data already stored in the buffer. Referring to FIG. 2, a simplified schematic representation of a conventional capture buffer is shown in which buffer wrap was enabled when the data shown was captured. The capture was stopped following Frame 9. Note that when the capture stopped, Frame 9 was complete. However it is possible that the last frame is not always a complete frame. In this case, the last complete frame is referred to as the chronologically newest frame. Also note that in Location N-1, Frame Data is shown as “ . . . ” which simply indicates valid frame data stored between location 12 and N. For our example, this valid frame data is not required to be known. It is a problem that the buffer start, i.e. the location within the buffer of the descriptor of the chronologically oldest complete data frame, becomes unknown when new data frames overwrite the original frame data already stored in the buffer.

In the example shown, frame 1 has been overwritten with frames 8 and 9. It can be seen that frame 9 is the chronologically newest frame. However, the chronologically oldest frame is now unknown since the “current field” of frame 9 has no meaning for locating the new chronologically oldest frame. In this example, this is now frame 2, with frame data 1₅ being a fragment of data that now has no meaning.

In the “Buffer Wrap” mode, navigating through the capture buffer can only be achieved by navigating backwards using the chronologically newest descriptor as described before. The Buffer Start location can also be found using this method, and is deemed as such when the last subtraction of a previous block size will take the location before that of the capture stop location. Again, as the buffer may contain millions of frames this can be a very slow process requiring a large number of processor cycles.

Improved performance is achieved when fewer processor cycles are required to access the frame data. A method and apparatus for achieving this is therefore required.

To check that an arbitrary location within the capture buffer contains a descriptor, typically, a number of conditions need to be met. Initially, a location is selected at random within the buffer. The location is identified as L. Starting from this location L, a number of conditions are tested relating to the size of the previous and current frames and the validity of their respective descriptors. This may have to be an iterative process depending on the level of the test conditions. If all the conditions are met then the location L is considered to be a descriptor. Then as before, to access other descriptors and their data frames, it is necessary to traverse a large number of descriptor pointers in the linked list to arrive at an area of interest. This can also be applied to finding the buffer start in a wrapped buffer mode.

This approach is not foolproof, as, although unlikely, it is possible that frame data can appear to be a descriptor. The more test conditions used to identify a location as a descriptor, the greater the likelihood that it is in fact a descriptor. A 100% guarantee is only achieved if all of the buffer has been tested to find a fully linked list, which is in fact slower than the navigation processes described above. Hence this method can still take a significant amount of time and even then is not foolproof. A method and system for storing data captured on a network is required that enables faster navigation through the capture buffer to identify the location of particular data frames.

According to a first aspect of the present invention, there is provided a capture buffer for capturing and storing data frames from a network, the capture buffer comprising: a data storage region for storing content data of the or each data frames received from the network and for storing a descriptor associated with the or each data frame received from the network; and an auxiliary storage region, for storing an indicator of a property of a or each frame.

Preferably, the auxiliary storage region is divided into a plurality of sub-regions each corresponding to a respective part of the data storage region, such that an indicator stored in a sub-region of the auxiliary region indicates information about the data stored in the corresponding part of the data storage region.

According to a second aspect of the present invention, there is provided a network analyser for connection to a network and for receiving data frames from the network, the network analyser comprising: a descriptor adder for adding a descriptor to each data frame received by the network analyser, the descriptor containing data about the frame to which it is attached; and a capture buffer for receiving and storing data frames with their associated descriptors, the capture buffer having data storage regions for storing content data of data frames received from the network and for storing the descriptor associated with or each data frame and auxiliary storage regions for storing an indicator of the location in the memory of the corresponding descriptor.

According to a third aspect of the present invention, there is provided a method of capturing network data at the network analyser from a network, the method comprising: at a network analyser receiving one or more data frames from the network; adding a descriptor to the or each received data frame, the descriptor containing information relating to the corresponding frame; storing the captured frame in a capture buffer associated with the network analyser and in an area of memory within the capture buffer, marking the location of the descriptor with a descriptor location indicator.

The invention provides a method of capturing network data and a capture buffer for capturing network data that enables a reliable way to locate a descriptor anywhere within the capture buffer. Thus, software is capable of randomly accessing the capture buffer and extracting the relevant data with minimal overhead in terms of time and processing cycles. Using the method and apparatus of the present invention, it is significantly quicker to locate a desired descriptor than in conventional systems when it was necessary to traverse a large number of descriptor pointers in a linked list to get to an area of interest. This is particularly so when the first frame of a wrapped buffer is required to be found.

According to another aspect of the present invention, there is provided a network analyser for connection to a network and for receiving data frames from the network, the network analyser comprising a capture buffer according to the fist aspect of the present invention.

Conventionally, to locate the position of the first (in chronological order) frame of data stored in a capture buffer it is necessary to start from the position of the last complete data frame written to the buffer and read the descriptor to identify the length of the previous frame. Next, the reader reads back in the buffer the number of locations corresponding to the length of the previous frame as identified from the descriptor of the current frame. At that position the reader repeats the process until the reader gets to a position that points to a location before the position of the capture stop, i.e. before the position of the most recently written data.

This means that the position of the last descriptor (before the reader got to the position before the position of the descriptor of the most recently written data frame) is the chronological start of the data in the capture buffer. As explained above, this is clearly a lengthy process as there may be millions of data frames in the capture buffer and the process can therefore take a significant time.

In an embodiment of the present invention it is possible simply to access a position in the capture buffer that was last written to, and then to find the next descriptor. This will necessarily be the location of the buffer start. Although possible, it is not then necessary to go through the linked list process to identify the start of the data in the capture buffer. This is quicker and significantly reduces the software overhead making the accessing and locating of data much quicker.

Examples of the present invention will now be described with reference to the accompanying drawings, in which:

FIG. 1 shows a schematic representation of a known capture buffer;

FIG. 2 shows a known representation of a capture buffer with buffer wrap enabled;

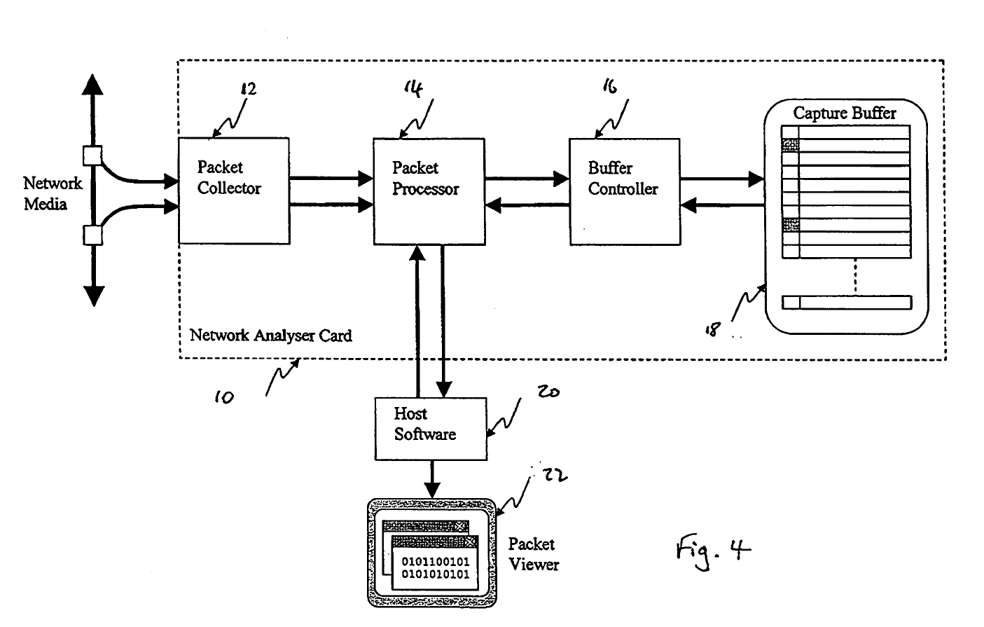

FIG. 3 shows a schematic representation of a capture buffer according to an embodiment of the present invention;

FIG. 4 shows a schematic representation of a network analyser card including a capture buffer according to an embodiment of the present invention.

FIGS. 1 and 2 show schematic representations of a known capture buffer. As explained above, with reference to FIG. 2, when buffer wrap is enabled to locate the buffer start it is necessary to traverse backwards through the buffer starting from the most recently written data frame to identify the location of the descriptor of the oldest (in chronological terms) complete data frame stored in the capture buffer. With current data rates and memory sizes, there can be many millions of data frames stored in the capture buffer and hence this process can take a long time.

FIG. 3 shows a schematic representation of a capture buffer according to an embodiment of the present invention.

The figure shows the buffer at two different times, the first time being shown in column 1 and the second time being shown in column 2. Referring to column 1, the same data structure as is stored in the capture buffer of FIG. 1 is shown. In other words, there are three complete data frames each having a descriptor. Data frame 1 together with its descriptor, is stored at locations 0 to 4 of the capture buffer, data frame 2 together with its descriptor is stored at locations 5 to 7 of the capture buffer and data frame 3 together with its descriptor is stored at locations 8 to 10 of the capture buffer. The capture buffer has N locations but in the example shown in FIG. 3, column 1, the data is not required for the example and is therefore unknown.

A region 6 is provided in the capture buffer memory. The region 6 is sub-divided into a plurality of sub-regions there being one allocated sub-region corresponding to each location 0 to N within the capture buffer. The region 6 and the corresponding sub-regions are used for storing data such as a flag to indicate whether or not the data stored in the corresponding region is a descriptor or not. In the example shown, where a descriptor is stored, a bit is set to 1 within the sub-region of the region 6 corresponding to that data frame. Thus, in the example shown, the sub-regions at locations 0, 5 and 8 each contain a bit set to 1.

In other words, the auxiliary storage region is divided into a plurality of sub-regions each corresponding to a respective part of the data storage region, such that an indicator stored in a sub-region of the auxiliary region indicates information about the data stored in the corresponding part of the data storage region. The physical location of the auxiliary region and the sub-regions may be such that each sub-region is contiguous with the part of the data storage region to which it corresponds.

As data is received by the capture buffer, the sub-region corresponding to the data frame is marked accordingly to indicate whether or not the data at that location has certain properties. In this example, the property being marked is whether or not the data is a frame descriptor.

When reading data from the capture buffer, to identify the location of a descriptor, the known region 6 of the capture buffer is accessed and read. Thus, in contrast to conventional capture buffers as shown in FIGS. 1 and 2, instead of having to access the content data of the data frames stored in the capture buffer, it is only necessary to access the region 6 and the corresponding sub-regions identified with each of the locations 0 to N. Thus, on one level, it is much quicker to identify the location of a descriptor since all that has to be done is that the value of a single bit must be determined.

The flag or bit in the region 6 and sub-regions corresponding to the locations 0 to N of the capture buffer are an example of an indicator suitable for identifying the location of a frame descriptor. It will be appreciated that other indicators may be used. What is important is that the use of the indicator enables the location of a descriptor to be quickly, easily and accurately identified without the need to access the content data of the stored data frames.

In a particularly preferred embodiment, the widening of the buffer (to accommodate the sub-regions) does not need to be a complex process as memories are now available that support Error Correction Coding (ECC) at little or no extra cost. These memories generally give the addition of an extra bit per Byte generally used for parity coding to ensure reliable storage and retrieval of data to and from the memory. Accordingly, one particularly preferred embodiment of the present invention involves the use of the extra ECC bits to mark the location of a descriptor or frame data with a unique identifying label.

Thus, in addition or as an alternative merely to identifying the location of frame descriptor within the capture buffer, the region 6 and corresponding sub-regions associated with each location in the capture buffer may be used to store other information relating to the content data stored in the corresponding region. For example, the type of data frame could be uniquely identified within the buffer. Another example of marking the captured data could be the encoding of individual capture operations as marked blocks within the capture buffer, or erroneous frames could be marked accordingly. These are of course merely examples of the possible non-obvious functionality that becomes available with the use of preferred embodiments of the present invention.

One preferred example of a suitable memory for use as the capture buffer is an ECC DIMM. In a typical ECC DIMM at each location within the memory, there is the capacity to store sixty four bits of data with eight bits of parity data. In a Double Data Rate (DDR) ECC DIMM, these numbers will effectively be doubled thus enabling eight bits to be used for parity, as required, and providing a further eight bits that may be used for marking the data as described above. Using this approach allows the use of the marking bits whilst still offering a level of protection against data errors.

Column 2 in FIG. 3 shows an example of a capture buffer in which buffer wrap is enabled. As in the example shown in FIG. 2, the data at location 4 (frame data 1, 4) is a fragment of data that now has no meaning. Accordingly, the “current field” of frame 9 has no meaning for locating the new first frame. The first frame is now frame 2.

Previously, to identify the location of the descriptor of frame 2 at location 5, it would have been necessary to start at the descriptor of frame 9 (location 1) and by taking the previous field from this descriptor determining the location of the previous descriptor (the descriptor of frame 8—not shown) and repeating this process until arriving at the descriptor of frame 2. Having arrived at the descriptor of frame 2, at location 5, the previous field would have indicated that the next previous descriptor would have been located at location 0 which is before the capture stop location of 3. Hence it would have then become known that the descriptor 2 at location 5 was the location of the buffer start.

With the capture buffer of FIG. 3, this process is no longer necessary. Rather, the location of the last frame written (frame 9) is noted. In this case, this is at location 1. Then, the sub-region of region 6 corresponding to each of the locations 2 to 5 are read and from this the location of the descriptor 2 at location 5 is identified. This is significantly quicker than having to traverse a large number of descriptor pointers in a linked list to get to an area of interest. Of course, this method can also be used when buffer wrap is not enabled and the same benefits are achieved.

As an example of the benefits provided by embodiments of the invention, compare a worst case scenario using known techniques and techniques of embodiments of the present invention. The worst case scenario for search times corresponds to the maximum supported frame size divided by the memory data width. For example, if the maximum frame size is 16,000 bytes, the minimum frame size is 64 bytes, memory width is 8 bytes, and the memory size is 1 GByte, then the worst case search time is the time required to search just 2000 locations (16,000/8=2000), regardless of the memory size. The best case is the time required to search just 8 locations (64/8).

Compared to the known navigation methods, starting at the newest frame and trying to locate the oldest at best case would be the time required to search 535,000 (1 Gbyte/2000 (16,000/8)) and at worst case the time required to search nearly 135 million (1 Gbyte/8(64/8)). Thus, significant improvements are achieved when using embodiments of the present invention.

FIG. 4 shows a schematic representation of a network analyser card including a capture buffer according to an embodiment of the present invention. The network analyser card 10 comprises a packet or frame collector 12 being a collection of components used to interface to the network media and extract frames or packets, or copies of packets from the network. The network analyser card also comprises a packet processor 14 in communication with a buffer controller 16, being coupled to a capture buffer 18. The Figure also shows host software 20 arranged to provide an interface to the packet processor 14 and provide a means for viewing packets captured using a packet viewer 22.

The packet processor 14 serves to count, classify and tag (i.e. add a descriptor to) received frames. In addition, it delivers data to the host (not shown) for use by software applications 20 running on the host.

The buffer controller 16 is arranged in communication both with the packet processor 14 and the capture buffer 18. The controller 16 serves to control the format of the capture buffer 18 and the transfer of data packets into and out of the capture buffer 18. The capture buffer 18 is for storing captured packets. As explained above, the buffer 18 includes sub-regions for the storage of indicator bits to identify, for example, the location of the descriptors within the capture buffer.

Last, the packet viewer 22 arranged on the host, is a graphic user interface, GUI, that enables the user of the network analyser on which the network analyser card 10 is arranged to view the captured packets that are stored in the capture buffer. It will be appreciated that the capture buffer 18 in the example shown in located on a network analyser card 10 that typically will be installed in some host. The host will most usually be a PC or other suitable computer. The capture buffer 18 operates in the manner described above with reference to FIG. 3.

It will be appreciated that the capture buffer 18 is implemented in the memory. The memory may be arranged internally or externally to an FPGA or ASIC. When arranged externally, it could be provided as an SDRAM or an SRAM. It is most preferred, as explained above, that the memory be provided as part of a Module, such as a DIMM. Other suitable types of memory module that could be used include Single Inline Memory Module (SIMM, Small Outline Dual Inline Memory Module (SODIMM), Micro Dual Inline Memory Module (Micro-DIMM), Fully Buffered Dual Inline Memory Module (FBDIMM), and Proprietary Memory Module. Any other suitable form of memory module can be used.

Embodiments of the present invention have been described with particular reference to the examples illustrated. However, it will be appreciated that variations and modifications may be made to the examples described within the spirit and scope of the present invention.

1. A capture buffer for storing data frames captured from a network, the capture buffer comprising:
a data storage region for storing content data of the or each data frame received from the network and for storing a descriptor associated with the or each data frame received from the network; and
an auxiliary storage region, for storing an indicator of a property of a frame.

2. A capture buffer according to claim 1, wherein the property of the frame is whether or not a particular block of a frame is the frame descriptor.

3. A capture buffer according to claim 1, wherein the data storage regions and the auxiliary storage region are provided in a memory.

4. A capture buffer according to claim 1, wherein the data storage region and auxiliary storage regions are provided in a memory module.

5. A capture buffer according to claim 1, wherein the auxiliary storage region is divided into a plurality of sub-regions each corresponding to a respective part of the data storage region, such that an indicator stored in a sub-region of the auxiliary region indicates information about the data stored in the corresponding part of the data storage region.

6. A capture buffer according to claim 1, wherein the memory module is a dual in-line memory module.

7. A capture buffer according to claim 1, wherein the indicator of the location of a frame descriptor comprises a set bit within the auxiliary storage region.

8. A capture buffer according to claim 1, wherein the auxiliary storage regions are defined within the Error Correction Coding region of the memory used to form the capture buffer.

9. A network analyser for connection to a network and for receiving data frames from the network, the network analyser comprising:
a descriptor adder for adding a descriptor to each data frame received by the network analyser, the descriptor containing data about the frame to which it is attached; and
a capture buffer for receiving and storing data frames with their associated descriptors, the capture buffer having data storage regions for storing content data of data frames received from the network and for storing the descriptor associated with or each data frame and an auxiliary storage region for storing an indicator of the location in the memory of the corresponding descriptor.

10. A network analyser according to claim 9, wherein the indicator is a flag indicative of the location at an identified location of the memory, of the corresponding frame descriptor.

11. A network analyser according to claim 9, comprising an indicator adder for adding the indicators at the auxiliary storage regions for indicating the location of the descriptors.

12. A network analyser according to claim 9, the network analyser being embodied on a network analyser card for connection to a host.

13. A method of capturing network data at a network analyser from a network, the method comprising:
at a network analyser receiving one or more data frames from the network;
adding a descriptor to the or each received data frame, the descriptor containing information relating to the corresponding frame;
storing the captured frame in a capture buffer associated with the network analyser, the storing comprising storing data content of the frame and the descriptor in a first region of memory in the capture buffer and in an auxiliary area of memory within the capture buffer, storing an indicator of a property of the frame.

14. A method according to claim 13, wherein storing an indicator of a property of the frame comprises marking the location of the descriptor within the capture buffer.

15. A method according to claim 14, wherein the step of marking the location of the descriptor comprises marking a flag in the memory to indicate the location of the descriptor.

16. A method according to claim 13, comprising using a region of memory normally used to store Error Correction Code bits to mark the location of a descriptor in the capture buffer.

17. A method according to claim 13, wherein the memory is a dual in-line memory module.
